(19) United States
(12) Patent Application Publication
(10) Pub. No.: US 2015/0168234 A1
(43) Pub. Date: Jun. 18, 2015

(54) MICROFLUIDIC DEVICE AND MEASURED-TEMPERATURE CORRECTING METHOD FOR THE MICROFLUIDIC DEVICE

(71) Applicant: CANON KABUSHIKI KAISHA, Tokyo (JP)

(72) Inventor: Yoichi Murakami, Newport News, VA (US)

(21) Appl. No.: 14/563,739

(22) Filed: Dec. 8, 2014

(30) Foreign Application Priority Data
Dec. 13, 2013 (JP) 2013-258007

(51) Int. Cl. G01K 15/00; G01K 7/16

(52) U.S. Cl. CPC G01K 15/005; G01K 7/16

(57) ABSTRACT

A microfluidic device includes a resistor that includes functions of heating a channel and measuring a temperature in the channel, and extends below the channel including a region of interest and over an area larger than the region of interest. The microfluidic device further includes a measuring unit that causes the resistor to measure a temperature distribution at two or more points, including the region of interest, directly above the resistor. The microfluidic device also includes a temperature correcting unit that corrects a temperature misread by an effect of ambient temperature on a resistor's resistance value.

### BACKGROUND

1. Field

Aspects of the present invention generally relate to a microfluidic device and a measured-temperature correcting method for the microfluidic device.

2. Description of the Related Art

A technology called a micro-total analysis system (μ-Tas) has been an active area of research and development in recent years. In the μ-Tas, all elements necessary for chemical and biochemical analyses are mounted on a single chip. The chip includes a microchannel, a temperature control mechanism, a concentration adjusting mechanism, a liquid sending mechanism, and a reaction detecting mechanism, and is generally called a microfluidic device. In particular, a DNA analysis device designed for the purpose of examining genetic information, such as a single nucleotide polymorphism (SNP) in the human genome, has been a focus of attention and actively studied.

A DNA analysis process involves the following two steps: (1) a DNA amplification step and (2) a DNA determination step.

The DNA amplification step in (1) generally involves the use of a polymerase chain reaction (PCR) technique. This is a technique that amplifies DNA by mixing an enzyme or the like with a primer complementary to part of the DNA to be amplified and then performing thermal cycling. The DNA amplification step requires temperature control to be performed with accuracy and at high speed for quicker reaction.

There are various ways to perform the DNA determination step in (2). For example, a thermal melting technique may be used in SNP determination. The thermal melting technique is a technique that detects a DNA melting temperature (hereinafter referred to as Tm) by gradually raising the temperature of a DNA solution after PCR. At low temperatures, DNA into which a fluorescent dye is intercalated has two strands. This allows detection of a fluorescence signal. When the temperature gradually increases and reaches Tm, the DNA is dissociated into single strands. This leads to a significant drop in the level of the fluorescence signal. From this relationship between the temperature and the fluorescence signal, the thermal melting technique determines Tm and detects SNP. The DNA determination step requires accurate temperature measurement, because DNA determination is made by comparing melting temperatures (Tm).

As described above, temperature control is important in the DNA analysis process. In particular, speed and accuracy are required here.

Japanese Patent Laid-Open No. 2012-193983 discloses a microfluidic device in which a plurality of heaters are arranged along a microchannel to allow rapid temperature changes in the microchannel.

Using a microfluidic device is a great advantage in terms of the speed of temperature control. This is because since various reactions take place in a microchannel having a small thermal capacity, high-speed heating and cooling are possible.

In the microfluidic device disclosed in Japanese Patent Laid-Open No. 2012-193983, a resistor serving both as a heater and a temperature sensor is disposed below the microchannel. This is to achieve accurate temperature control, and particularly to achieve accurate measurement of temperature in the microchannel. The temperature control is performed by associating the temperature in the microchannel with the resistance value of the resistor.

A microfluidic device is advantageous in that, because of the small thermal capacity of its components, it can accelerate heat transfer and perform temperature control at high speed. However, due to the small thermal capacity, the components (particularly a resistor serving as a temperature sensor) are susceptible to changes in environment around the device. For example, the resistor is susceptible to temperature changes and may indicate a wrong temperature (which may hereinafter be referred to as a misread temperature). This challenge for the microfluidic device will now be described.

FIG. 2 schematically illustrates a microchip included in a microfluidic device and shows temperature profiles in the longitudinal direction of a resistor of the microfluidic device.

By using the microchip illustrated in FIG. 2 as a model, the amount of change in resistor's resistance value caused by a change in ambient temperature and the amount of temperature misreading determined from the amount of change in resistor's resistance value were calculated by simulation. The model used in the calculation will now be described in detail.

A microchip 28 illustrated in FIG. 2 includes two 0.5-mm-thick glass substrates (having a thermal conductivity of 1.4 W/m/K at 20° C.). Of the two substrates, an upper substrate 24 is 10 mm by 30 mm in size and a lower substrate 25 is 15 mm by 30 mm in size. The upper substrate 24 has a microchannel 26 which is 20 μm deep, 180 μm wide, and 20 mm long. The lower substrate 25 is provided with a resistor 27 which is 100 nm thick, 300 μm wide, and 15 mm long.

The resistance value of the resistor 27 was 100Ω at 20° C., and the temperature resistance coefficient TCR of the resistor 27 was 2500 (10⁻⁶/K). The ambient temperature of the microchip 28 was set to 20° C. and 25° C., and the temperature in a region of interest 21 in the center of the resistor 27 was about 70° C. The temperature control involved the use of a relationship that associates the temperature in the region of interest 21 with the resistance value of the resistor 27. The temperature control was performed by controlling heat generated by Joule heating when a voltage was applied to the resistor 27.

A comparison between a temperature profile 22 at an ambient temperature of 20° C. and a temperature profile 23 at an ambient temperature of 25° C. indicates that an increase in ambient temperature causes an increase in temperature at end portions of the resistor 27. This leads to an increase in resistance value at the end portions of the resistor 27, and results in an increase in the resistance value of the entire resistor 27. That is, even when the temperature in the region of interest 21 does not change and the same temperature is shown, the measured resistance value of the resistor 27 is changed by the change in ambient temperature. This results in misreading of a measured temperature in the region of interest 21.

In the simulation, the resistance value of the resistor 27 was 112.5Ω and the temperature in the region of interest 21 was 70° C. at an ambient temperature of 20° C. However, the resistance value of the resistor 27 was increased to 112.525Ω at an ambient temperature of 25° C. As described above, the temperature in the region of interest 21 was associated with the resistance value of the resistor 27. Therefore, due to the relationship with this increased resistance value, the temperature in the region of interest 21 was misread as being increased to 70.1° C. even though it did not actually change.

As can be seen from above, the temperature in the region of interest is misread because the resistance value of the resistor in the microfluidic device is affected by the change in ambient temperature. That is, to accurately evaluate the temperature in the region of interest, it is necessary to correct the misreading described above.

### SUMMARY

Aspects of the present invention generally provide a microfluidic device that corrects a temperature misread by the effect of ambient temperature on the resistance value of a resistor included in the microfluidic device.

According to an aspect of the present invention, a microfluidic device controls a temperature in a region of interest by using a resistance value of a resistor. The region of interest is a temperature measurement region. The resistance value is used in a relational expression associating the resistance value of the resistor with the temperature in the region of interest. The resistor serves both as a heater for heating a channel in a substrate included in the microfluidic device and a sensor for measuring a temperature in the channel. The resistor extends below the channel including the region of interest, along a longitudinal direction of the channel, and over an area larger than the region of interest. The microfluidic device includes a measuring unit configured to cause the resistor to measure a temperature distribution at any two or more points directly above the resistor, where the two or more points include the region of interest, and a temperature correcting unit configured to correct a temperature misread by an effect of a change in ambient temperature on the resistance value of the resistor. The temperature correcting unit compares a temperature distribution measured by the measuring unit when the relational expression associating the resistance value of the resistor with the temperature in the region of interest is determined before a main measurement, with a temperature distribution measured by the measuring unit when the temperature in the region of interest is controlled by using the relational expression in the main measurement, and corrects the misread temperature.

Further features of the present disclosure will become apparent from the following description of exemplary embodiments with reference to the attached drawings.

### BRIEF DESCRIPTION OF THE DRAWINGS

FIG. 1 illustrates a configuration of a microfluidic device according to an exemplary embodiment.

FIG. 2 schematically illustrates a microchip included in a microfluidic device and shows temperature profiles in the longitudinal direction of a resistor of the microfluidic device.

FIG. 3 illustrates a process of a measured-temperature correcting method that corrects a temperature measured in a region of interest in the microfluidic device according to the exemplary embodiment.

FIG. 4 conceptually illustrates a temperature distribution measured at any two points directly above a resistor in the process of the measured-temperature correcting method according to the exemplary embodiment.

FIG. 5 conceptually illustrates a temperature distribution measured over the entire region directly above a resistor in the process of the measured-temperature correcting method according to the exemplary embodiment.

FIG. 6 schematically illustrates a configuration of a microchip associated with examples of the present disclosure.

FIG. 7 schematically illustrates a region of interest specified in Examples 1 to 4 of the present disclosure.

FIG. 8 schematically illustrates an arrangement of micro-regions for determining an intra-channel temperature distribution over the entire region directly above the resistor in Example 1.

FIG. 9 schematically illustrates an arrangement of micro-regions for determining an intra-channel temperature distribution at any two points directly above the resistor in Example 2.

FIG. 10 conceptually illustrates a table showing predetermined integrated values and the amounts of correction for temperature misreading in Example 3.

FIG. 11 conceptually illustrates a table showing predetermined difference values and the amounts of correction for temperature misreading in Example 4.

### DESCRIPTION OF THE EMBODIMENTS

A microfluidic device and a measured-temperature correcting method for the microfluidic device according to an exemplary embodiment will now be described.

A microfluidic device controls a temperature in a region of interest by using a resistance value of a resistor. The region of interest is a temperature measurement region. The resistance value is used in a relational expression associating the resistance value of the resistor with the temperature in the region of interest. The resistor serves both as a heater for heating a channel in a substrate included in the microfluidic device and a sensor for measuring a temperature in the channel. The resistor extends below the channel including the region of interest, along a longitudinal direction of the channel, and over an area larger than the region of interest. The microfluidic device includes a measuring unit configured to cause the resistor to measure a temperature distribution at any two or more points directly above the resistor, the two or more points including the region of interest; and a temperature correcting unit configured to correct a temperature misread by an effect of a change in ambient temperature on the resistance value of the resistor. The temperature correcting unit is configured to compare a temperature distribution measured by the measuring unit when the relational expression associating the resistance value of the resistor with the temperature in the region of interest is determined before a main measurement, with a temperature distribution measured by the measuring unit when the temperature in the region of interest is controlled by using the relational expression in the main measurement, and correct the misread temperature.

The temperature correcting unit may integrate differences between the temperature distribution measured before the main measurement and the temperature distribution measured in the main measurement for the entire region directly above the resistor, the entire region being in the channel, and calculate the amount of correction by using the resulting integrated value.

The temperature correcting unit may determine a difference between the temperature distributions at any point in the channel, such as a position corresponding to an end portion of the resistor, and calculate the amount of correction by using the determined difference.

The temperature correcting unit may integrate differences between the temperature distributions for the entire region directly above the resistor, the entire region being in the channel, select a closest temperature distribution from predetermined temperature distributions by using the resulting integrated value, and calculate the amount of correction.

The temperature correcting unit may determine a difference between the temperature distributions at any point in the channel, such as a position corresponding to an end portion of the resistor, select a closest temperature distribution from predetermined temperature distributions by using the determined difference, and calculate the amount of correction.

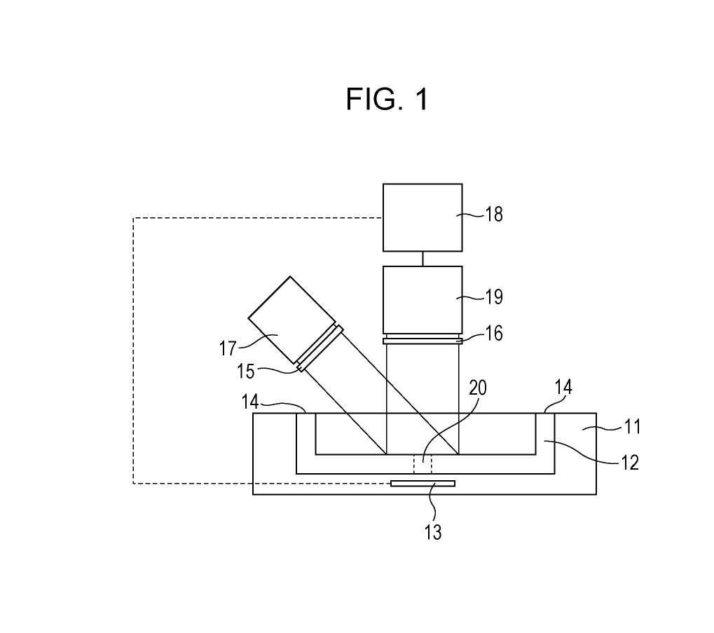

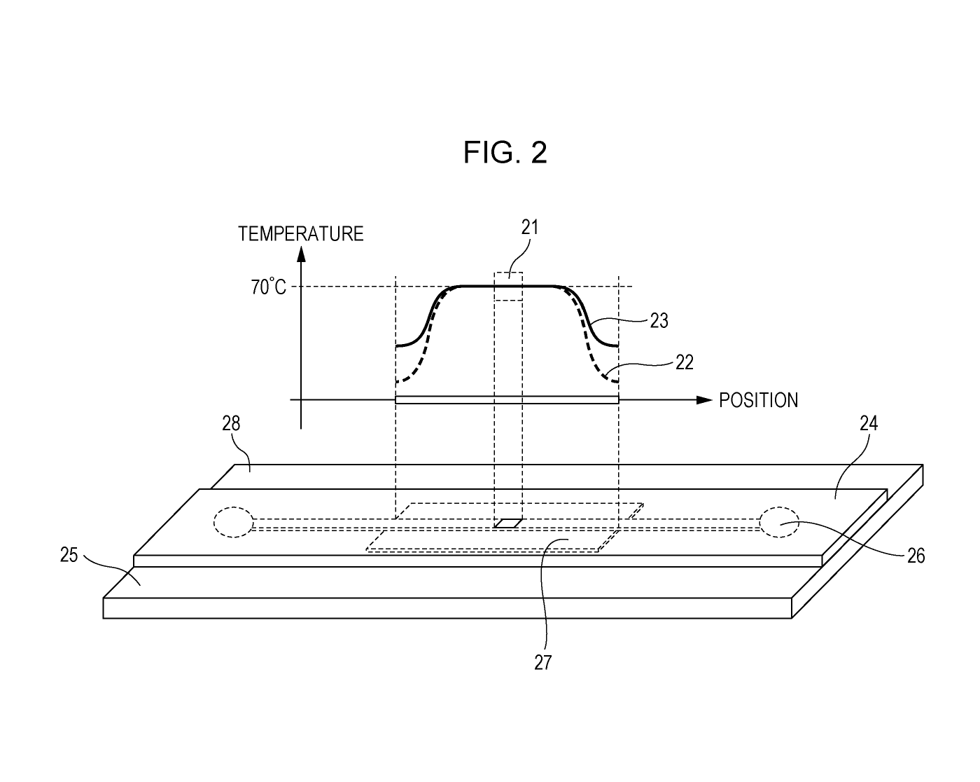

A configuration of a microfluidic device according to the present embodiment will be described in detail with reference to FIG. 1.

Referring to FIG. 1, a microchip 11 has a microchannel 12 with ports 14, which allow the flow of a reagent into and out of the microchannel 12. The microchip 11 may be made of a transparent glass material, such as quartz, for fluorescent observation of the reagent in the microchannel 12.

The temperature in a region of interest 20 in the microchannel 12 is varied and measured by a resistor 13 which serves both as a heater and a temperature sensor. To maintain temperature uniformity in the region of interest 20, the resistor 13 having a pattern area larger than that of the region of interest 20 in the microchannel 12 is provided. The resistor 13 may be made of a resistance thermometer material, such as platinum or copper. A thermistor may be used as the resistor 13.

For measurement of fluorescent brightness of the reagent introduced into the microchannel 12, the reagent in the microchannel 12 is irradiated with light from a light source 17 through a filter 15, so that a fluorescent dye is excited and emits light. The resulting fluorescence signal is received by a camera 19 through a filter 16, and the corresponding image data is recorded in a personal computer (PC) 18.

The PC 18 controls the overall operation of the microfluidic device. Specifically, the PC 18 controls the operation which involves comparing a temperature distribution measured by the measuring unit at a reference ambient temperature in a preliminary measurement before a main measurement with a temperature distribution measured by the measuring unit at an ambient temperature in the main measurement, correcting a temperature measured in the region of interest in the main measurement, and applying a voltage to the resistor 13.

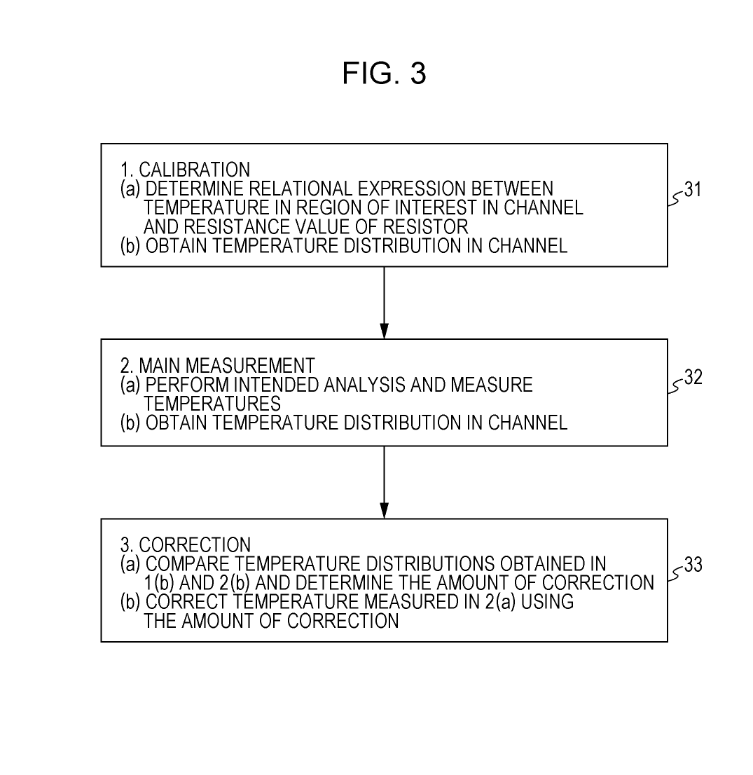

FIG. 3 illustrates a process for correcting a temperature measured in a region of interest. A temperature distribution measurement and a method for correcting a temperature measured in a region of interest according to the present embodiment will be described with reference to FIG. 3.

First, a calibration in step 31 is performed. The calibration involves two steps, step 31(a) and step 31(b). Step 31(a) determines a relational expression between a temperature in a region of interest in a channel and a resistor's resistance value. This relational expression is necessary for controlling the temperature in the region of interest in a main measurement in the next step (step 32). Step 31(b) obtains a temperature distribution. These two steps, step 31(a) and step 31(b), are performed at the same time.

For example, when the resistor is made of a material having a linear relationship between a temperature and a resistance value, the following relational expression (1) is used:

T=k₁×R+k₀ (1)

where T is a temperature in the region of interest, R is a resistor's resistance value, and k₁ and k₀ are unknown coefficients. The association between the temperature in the region of interest and the resistor's resistance value is made by determining the coefficients. The relational expression (1) may be determined by introducing a DNA reagent having a known Tm into a channel and making an association with the resistance value during thermal melting. The association may be made by using the temperature responsiveness of fluorescent brightness of the reagent.

Step 31(b) for obtaining a temperature distribution involves recording image data of the fluorescence signal directly above the resistor, and calculating temperatures in the channel by using a measuring unit for measuring a temperature distribution at two or more points directly above the resistor and along the channel. The two or more points include the region of interest in the channel.

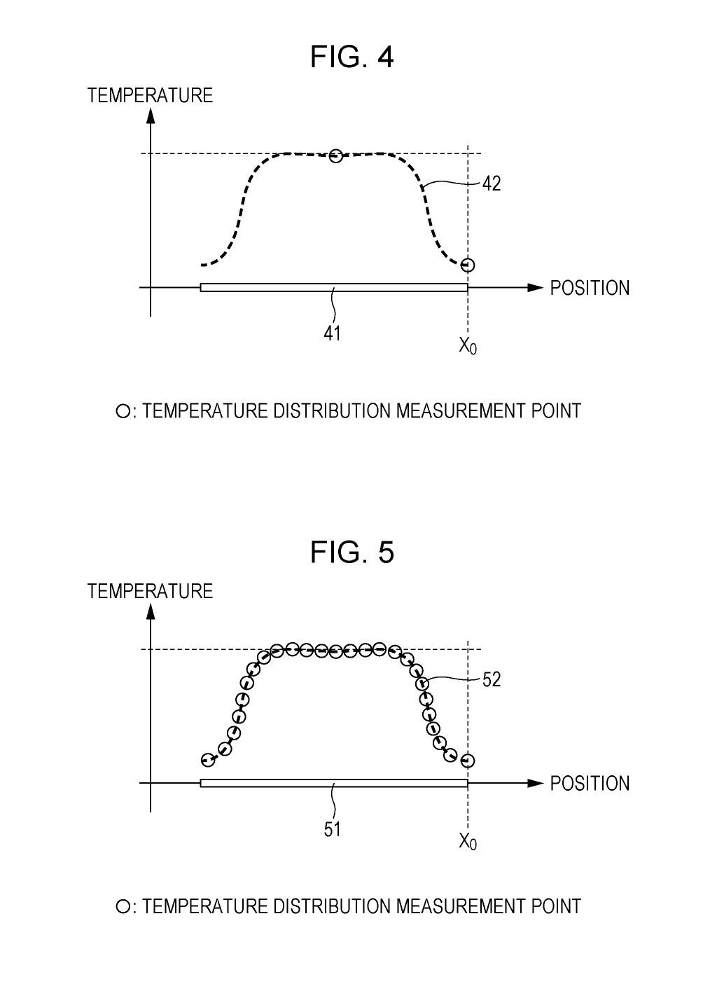

FIGS. 4 and 5 illustrate points for measuring a temperature distribution. As illustrated in FIG. 4, the temperature distribution may be measured at any two points, including the region of interest, directly above the resistor. Of the two points for measuring the temperature distribution, one is the region of interest used in step 31(a). The other of the two points may be a position located in the channel and corresponding to an end portion of a resistor 41. This is because as compared to the resistor's center portion corresponding to the region of interest, end portions of the resistor 41 are lower in temperature and more sensitive to changes in environment, so that improved correction accuracy can be achieved. Alternatively, as illustrated in FIG. 5, the temperature distribution can be measured over the entire region directly above a resistor 51.

Next, a main measurement in step 32 is performed. The main measurement also involves two steps, step 32(a) and step 32(b). Step 32(a) performs DNA amplification and analysis in the region of interest by using the relational expression determined in the calibration. For example, when a thermal melting technique is used in SNP determination, Tm of the specimen is determined.

In conjunction with the analysis in step 32(a), step 32(b) records image data of the fluorescence signal directly above the resistor, and measures a temperature distribution at the same positions as those for measuring the temperature distribution in the calibration.

Last, a correction in step 33 is performed. The correction involves comparing the two temperature distributions obtained in the calibration and the main measurement, calculating the amount of correction, and correcting the temperature measured in the main measurement.

The comparison between the temperature distributions and the calculation of the amount of correction may be made by integrating differences between the temperature distributions obtained in the calibration and the main measurement for the entire region directly above the resistor. The comparison between the temperature distributions and the calculation of the amount of correction may be made by determining a difference between the temperature distributions obtained in the calibration and the main measurement for the same position, and calculating the amount of correction by using the difference as a representative value. The relationship between the difference used as a representative value and the amount of correction may be determined either from actual data or by simulation. The comparison between the temperature distributions and the calculation of the amount of correction may be made by determining a difference between the temperature distributions obtained in the calibration and the main measurement for the same position, selecting a closest temperature distribution from predetermined temperature distributions by using the difference as a representative value, and using the corresponding amount of correction. The comparison between the temperature distributions and the calculation of the amount of correction may be made by integrating differences between the temperature distributions obtained in the calibration and the main measurement for the entire region directly above the resistor, selecting a closest temperature distribution from predetermined temperature distributions by using the integrated value, and using the corresponding amount of correction. The predetermined temperature distributions may be determined either from actual data or by simulation.

### EXAMPLES

Examples of the present disclosure will now be described. The present disclosure is not seen to be limited by the exemplary embodiments and the examples described below.

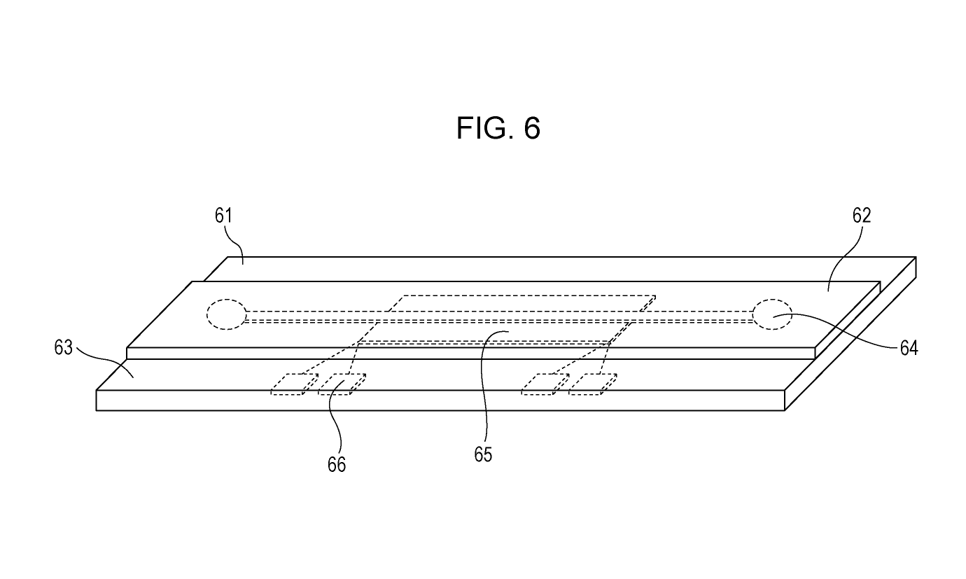

First, a microfluidic device used in the examples will be described. FIG. 6 illustrates a microchip prepared in the examples. A microchip 61 was made by bonding two 0.5-mm-thick glass substrates together. Of the two substrates, an upper substrate 62 is 10 mm by 30 mm in size and a lower substrate 63 is 15 mm by 30 mm in size. The upper substrate 62 has a microchannel 64 formed by dry etching. The microchannel 64 is 20 μm deep, 180 μm wide, and 20 mm long. Inlets for introducing a reagent were made by drilling through the upper substrate 62. The lower substrate 63 is provided with a resistor 65 which is a 300-μm-wide and 15-mm-long pattern formed by sputter deposition of about a 100-nm-thick layer of platinum and photolithography. As electrodes (electrode wiring) 66 of the resistor 65, a pattern was formed by sequential sputter deposition of a 300-nm-thick titanium-gold-titanium layer and photolithography. After patterning the resistor 65 and the electrodes 66, an oxide silicon layer of about 1 μm thick was formed on the lower substrate 63 by chemical-vapor deposition (CVD) for insulation from the microchannel 64. Next, the surfaces of the upper substrate 62 and the lower substrate 63 were altered by plasma irradiation. Last, the upper substrate 62 and the lower substrate 63 were bonded together to form the microchip 61.

Next, a configuration of the microfluidic device will be described with reference to FIG. 1. For measurement of the fluorescent brightness of the reagent introduced into the channel, the reagent in the channel was irradiated with light from a light-emitting diode (LED) serving as the light source 17 through the filter 15, so that the fluorescent dye was excited and emitted light. The resulting fluorescence signal was received by the camera 19 through the filter 16, and the corresponding image data was recorded in the PC 18.

A detailed description will now be given of a method in which, by using the microfluidic device described above, the temperature measured in the region of interest in the channel is corrected through the use of temperature distributions. In the examples described below, a correction was made in accordance with the process of correcting the temperature measured in the region of interest (see FIG. 3). To cause the occurrence of temperature misreading, the ambient temperature during the calibration was set to 20° C., and the ambient temperature during the main measurement was set to 25° C. Then the effect of the correction was evaluated.

First, Comparative Example will be described. Comparative Example determines Tm without performing the correcting method of the present disclosure. In Comparative Example, the temperature measured in the region of interest is misread due to an increase in ambient temperature. The description of Comparative Example is followed by that of Examples 1 to 4 in which the measured-temperature correcting process of the present disclosure can correct the misreading of the measured temperature. In Examples 1 to 4, a method for comparing temperature distributions will be described in detail.

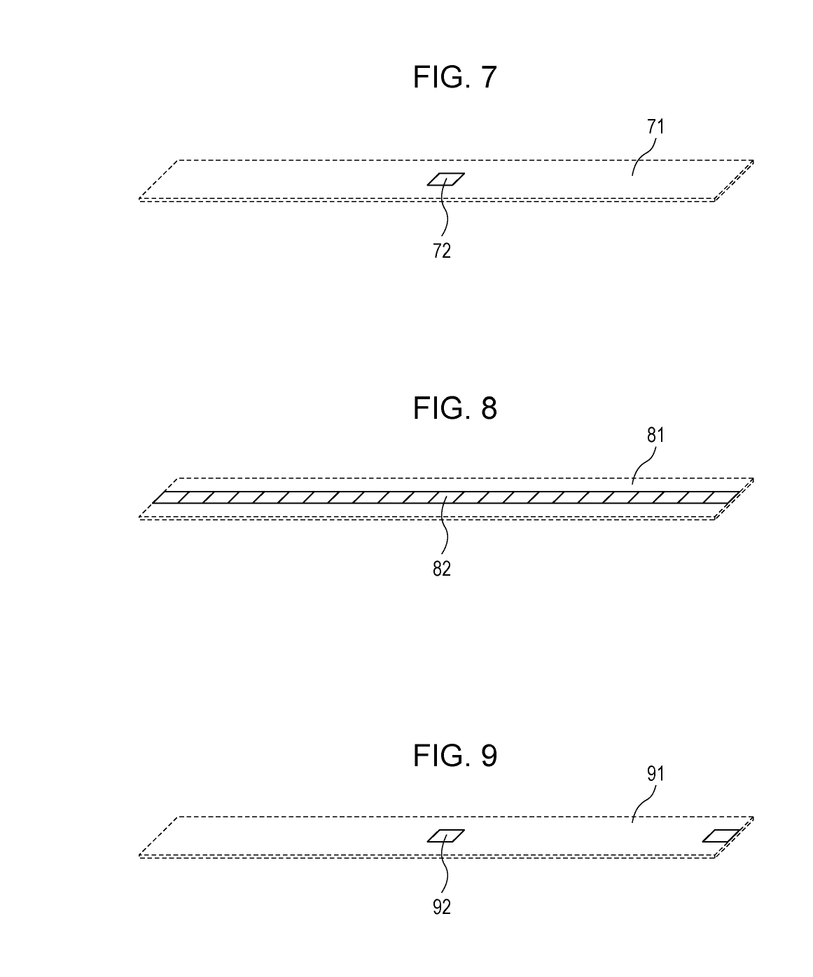

FIG. 7 illustrates a region of interest specified in Examples 1 to 4. In Comparative Example and Examples 1 to 4 described below, a region of interest 72 in the channel during the calibration and the main measurement is 100 μm wide and 1 mm long and is located directly above the center of a resistor 71. The temperature measurement in the region of interest 72 and the determination of temperature distributions in the calibration and the main measurement were made by measuring Tm of a DNA amplification product solution having a known Tm through the use of a thermal melting technique.

### COMPARATIVE EXAMPLE

In Comparative Example, for a calibration, two types of DNA amplification product solutions designed to have Tm of 70° C. and 90° C. were introduced into the channel. The temperature in the microfluidic device during the calibration was set to 20° C. Then, a voltage was applied to the resistor through the use of the PC, a DNA thermal melting reaction was produced in the channel, and the resistor's resistance value during the thermal melting was measured. The resistor's resistance value was 112.5Ω at a Tm of 70° C. and 117.5Ω at a Tm of 90° C. From this result, k₀ and k₁ were found to be −380 and 4, respectively.

Next, a main measurement was performed. A DNA amplification product solution designed to have a Tm of 70° C. was introduced into the channel. The temperature in the microfluidic device during the main measurement was set to 25° C. Then, a voltage is controlled by using the relational expression determined in the calibration, and a thermal melting technique was performed in the region of interest. The thermal melting occurred at 112.525Ω. By using the relational expression, the measured temperature was found to be 70.1° C.

Comparative Example shows that when the correcting method of the present disclosure is not performed, temperature misreading occurs due to an increase in ambient temperature. When the ambient temperature was increased by 5° C., the amount of temperature misreading in the region of interest was 0.1° C.

### Example 1

In Example 1, temperature distributions obtained in the calibration and the main measurement were compared for the entire region directly above the resistor. Differences between corresponding points in the temperature distributions obtained in the calibration and the main measurement were integrated for the entire region. Then, the amount of correction was calculated, and the correction was made.

First, the calibration was performed in the same manner as in Comparative Example, and a relational expression having the same coefficients as those in Comparative Example was obtained. The temperature in the microfluidic device during the calibration was set to 20° C. To obtain the temperature distribution in the channel (which may hereinafter be referred to as an intra-channel temperature distribution) for the entire region directly above the resistor, an image of the fluorescence signal was captured for the entire region directly above the resistor. The process described so far applies to the following examples and thus will not be described in the following examples.

FIG. 8 illustrates an arrangement of micro-regions for determining an intra-channel temperature distribution over the entire region directly above a resistor. In the measurement of an intra-channel temperature distribution directly above a resistor 81, a center portion in the channel is divided into micro-regions along the longitudinal direction in a recorded image as illustrated in FIG. 8. For uniform fluorescent brightness, the micro-regions each were set to be 100 μm wide and 1 mm long, which is the same as a region of interest 82 in the center. A resistance value distribution over the entire region directly above the resistor 81 was obtained by determining the resistance value for each of the micro-regions during the thermal melting.

For convenience in the correcting process, the resistance value was converted to a resistance value per unit length, and the distribution of resistance values per unit length in the channel was determined. In the resistance value distribution, the resistance value is larger at a position of lower temperature in the channel. Therefore, the positive and negative signs were reversed for correspondence to the intra-channel temperature distribution.

Next, a main measurement was performed. As in Comparative Example, a DNA amplification product solution designed to have a Tm of 70° C. was introduced into the channel. The temperature in the microfluidic device during the main measurement was set to 25° C., and Tm was determined with a thermal melting technique. Tm in the region of interest was 70.1° C. At the same time, in the same manner as that for deriving a resistance value distribution in the calibration, a resistance value distribution per unit length in the main measurement was determined.

Last, a correction was performed. Differences between the temperature distributions obtained in the calibration and the main measurement were determined for the entire region of the resistance value distribution per unit length. Then, the sum total of the differences was calculated, and the amount of temperature misreading was calculated using the relational expression determined in the calibration. The sum total was 0.025Ω, and the amount of correction was calculated to be 0.1° C. using the relational expression determined in the calibration. With this value, Tm in the region of interest in the main measurement was corrected.

### Example 2

In Example 2, a region of interest and a position corresponding to an end portion of the resistor were selected as any two points directly above the resistor in the calibration and the main measurement. A difference between temperature distributions obtained in the calibration and the main measurement was determined for each of the two points. Then, the amount of correction was calculated using the difference as a representative value, and the correction was made.

FIG. 9 illustrates an arrangement of micro-regions for determining an intra-channel temperature distribution at any two points directly above the resistor. In the measurement of an intra-channel temperature distribution directly above a resistor 91, any two points along the longitudinal direction of a center portion in the channel were selected and set as micro-regions in a recorded image. For uniform fluorescent brightness, the micro-regions each were set to be 100 μm wide and 1 mm long, which is the same as a region of interest 92.

In Example 2, two points, the region of interest 92 and the position corresponding to an end portion of the resistor 91, were selected and set as micro-regions. Then, a Tm distribution in the channel was obtained by determining Tm for each of the micro-regions. In the Tm distribution, Tm is larger at a position of lower temperature in the channel. Therefore, the positive and negative signs were reversed for correspondence to the intra-channel temperature distribution.

Next, a main measurement was performed. As in Comparative Example, a DNA amplification product solution designed to have a Tm of 70° C. was introduced into the channel. The temperature in the microfluidic device during the main measurement was set to 25° C., and Tm was determined with a thermal melting technique. Tm in the region of interest was 70.1° C. At the same time, in the same manner as that for deriving an intra-channel temperature distribution (Tm distribution) in the calibration, an intra-channel temperature distribution in the main measurement was determined.

Last, a correction was performed. A difference between the temperature distributions obtained in the calibration and the main measurement was determined for a position corresponding to an end portion of the resistor. Then, the amount of correction for temperature misreading was calculated from a relationship between a difference value and the amount of correction for temperature misreading determined by simulation. The amount of correction was calculated to be 0.1° C. With this value, Tm in the region of interest in the main measurement was corrected.

### Example 3

In Example 3, temperature distributions obtained in the calibration and the main measurement were compared for the entire region directly above the resistor. Differences between the temperature distributions obtained in the calibration and the main measurement were integrated for the entire region directly above the resistor. By using the integrated value, a closest temperature distribution was selected from predetermined temperature distributions. Then, the amount of correction was determined, and the correction was made.

As in Example 1, Tm was determined for each of micro-regions, such as those illustrated in FIG. 8, and a Tm distribution was determined as a temperature distribution. In the Tm distribution, as described in Example 1, Tm is larger at a position of lower temperature in the channel. Therefore, the positive and negative signs were reversed for correspondence to the intra-channel temperature distribution.

Next, a main measurement was performed. As in Comparative Example, a DNA amplification product solution designed to have a Tm of 70° C. was introduced into the channel. The temperature in the microfluidic device during the main measurement was set to 25° C., and Tm was determined with a thermal melting technique. Tm in the region of interest was 70.1° C. At the same time, in the same manner as that for deriving an intra-channel temperature distribution (Tm distribution) in the calibration, an intra-channel temperature distribution in the main measurement was determined.

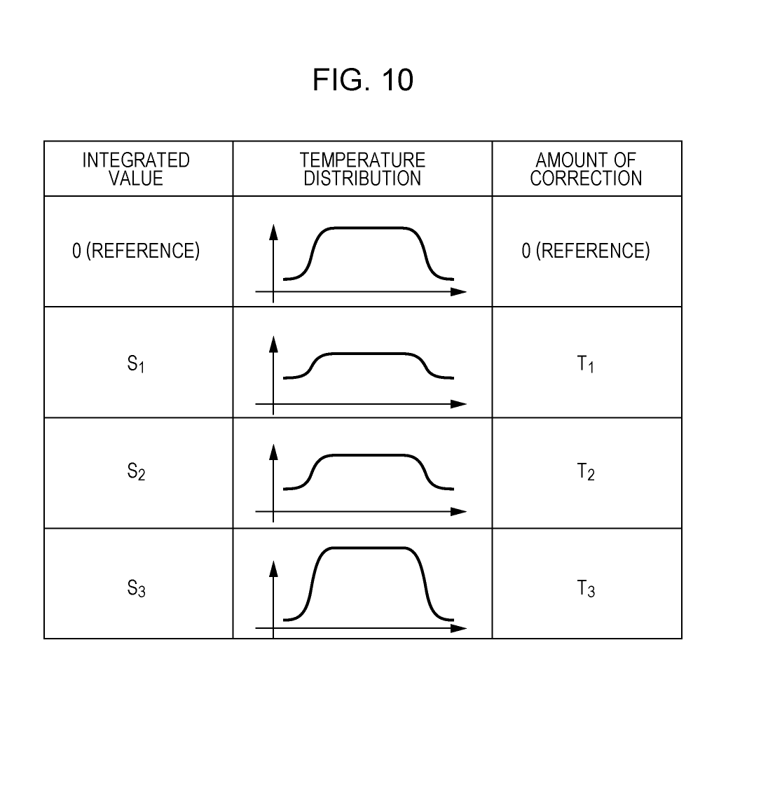

Last, a correction was performed. Differences between the temperature distributions obtained in the calibration and the main measurement were determined for the entire region directly above the resistor, and their integrated value was calculated. FIG. 10 conceptually illustrates a table showing predetermined integrated values and the amounts of correction for temperature misreading. The table shown in FIG. 10 was obtained by simulation in advance. Then the amount of correction corresponding to the integrated value calculated in the present process was selected. The selected amount of correction was calculated to be 0.1° C. With this value, Tm in the region of interest in the main measurement was corrected.

### Example 4

In Example 4, a region of interest and a position corresponding to an end portion of the resistor were selected as any two points directly above the resistor in the calibration and the main measurement. A difference between temperature distributions obtained in the calibration and the main measurement was determined for each of the two points. By using the difference as a representative value, a closest temperature distribution was selected from predetermined temperature distributions, and the amount of correction was obtained.

As in Example 2, two points, a region of interest and a position corresponding to an end portion of the resistor, were selected and set as micro-regions as in FIG. 9. Then, a Tm distribution in the channel was obtained by determining Tm for each of the micro-regions. In the Tm distribution, Tm is larger at a position of lower temperature in the channel. Therefore, the positive and negative signs were reversed for correspondence to the intra-channel temperature distribution.

Next, a main measurement was performed. As in Comparative Example, a DNA amplification product solution designed to have a Tm of 70° C. was introduced into the channel. The temperature in the microfluidic device during the main measurement was set to 25° C., and Tm was determined with a thermal melting technique. Tm in the region of interest was 70.1° C. At the same time, in the same manner as that for deriving an intra-channel temperature distribution (Tm distribution) in the calibration, an intra-channel temperature distribution in the main measurement was determined.

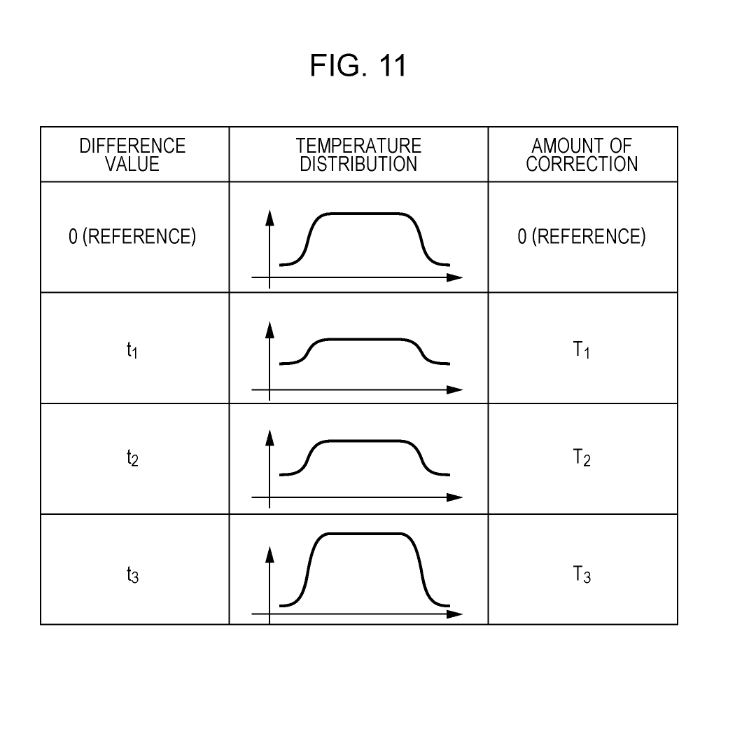

Last, a correction was performed. FIG. 11 conceptually illustrates a table showing predetermined difference values and the amounts of correction for temperature misreading. A difference between the temperature distributions obtained in the calibration and the main measurement was determined for a position corresponding to an end portion of the resistor, and the table shown in FIG. 11 was obtained by simulation in advance. Then, the amount of correction corresponding to the difference value calculated in the present process was selected. The selected amount of correction was calculated to be 0.1° C. With this value, Tm in the region of interest in the main measurement was corrected.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-258007 filed Dec. 13, 2013, which is hereby incorporated by reference herein in its entirety.

What is claimed is:

1. A microfluidic device that controls a temperature in a region of interest by using a resistance value of a resistor, the region of interest being a temperature measurement region, the resistance value being used in a relational expression associating the resistance value of the resistor with the temperature in the region of interest, the resistor serving both as a heater for heating a channel in a substrate included in the microfluidic device and a sensor for measuring a temperature in the channel, the resistor extending below the channel including the region of interest, along a longitudinal direction of the channel, and over an area larger than the region of interest, the microfluidic device comprising:
a measuring unit configured to cause the resistor to measure a temperature distribution at any two or more points directly above the resistor, wherein the two or more points include the region of interest; and
a temperature correcting unit configured to correct a temperature misread by an effect of a change in ambient temperature on the resistance value of the resistor,
wherein the temperature correcting unit compares a temperature distribution measured by the measuring unit when the relational expression associating the resistance value of the resistor with the temperature in the region of interest is determined before a main measurement, with a temperature distribution measured by the measuring unit when the temperature in the region of interest is controlled by using the relational expression in the main measurement, and corrects the misread temperature.

2. The microfluidic device according to claim 1, wherein the temperature correcting unit integrates differences between the temperature distribution measured before the main measurement and the temperature distribution measured in the main measurement for an entire region directly above the resistor, and calculates an amount of correction for correcting the misread temperature.

3. The microfluidic device according to claim 1, wherein the temperature correcting unit determines a difference between the temperature distribution measured before the main measurement and the temperature distribution measured in the main measurement for any point in the channel, and calculates an amount of correction for correcting the misread temperature.

4. The microfluidic device according to claim 1, wherein the temperature correcting unit integrates differences between the temperature distribution measured before the main measurement and the temperature distribution measured in the main measurement for an entire region directly above the resistor, selects a closest temperature distribution from predetermined temperature distributions by using the integrated value, and calculates an amount of correction for correcting the misread temperature.

5. The microfluidic device according to claim 1, wherein the temperature correcting unit determines a difference between the temperature distribution measured before the main measurement and the temperature distribution measured in the main measurement for any point in the channel, selects a closest temperature distribution from predetermined temperature distributions by using the determined difference, and calculates an amount of correction for correcting the misread temperature.

6. The microfluidic device according to claim 3, wherein the point in the channel is a position in the channel, the position corresponding to an end portion of the resistor.

7. A measured-temperature correcting method for a microfluidic device that controls a temperature in a region of interest by using a resistance value of a resistor, the region of interest being a temperature measurement region, the resistance value being used in a relational expression associating the resistance value of the resistor with the temperature in the region of interest, the resistor serving both as a heater for heating a channel in a substrate included in the microfluidic device and a sensor for measuring a temperature in the channel, the resistor extending below the channel including the region of interest, along a longitudinal direction of the channel, and over an area larger than the region of interest, the measured-temperature correcting method comprising:
causing the resistor to measure a temperature distribution at any two or more points directly above the resistor, wherein the two or more points include the region of interest; and
correcting a temperature misread by an effect of a change in ambient temperature on the resistance value of the resistor,
wherein, when the relational expression associating the resistance value of the resistor with the temperature in the region of interest is determined before a main measurement, the measured temperature distribution is compared with a temperature distribution measured when the temperature in the region of interest is controlled by using the relational expression in the main measurement, and the misread temperature is corrected.

8. The measured-temperature correcting method according to claim 7, further comprising integrating differences between the temperature distribution measured before the main measurement and the temperature distribution measured in the main measurement for an entire region directly above the resistor and calculating an amount of correction for correcting the misread temperature.

9. The measured-temperature correcting method according to claim 7, further comprising determining a difference between the temperature distribution measured before the main measurement and the temperature distribution measured in the main measurement for any point in the channel and calculating an amount of correction for correcting the misread temperature.

10. The measured-temperature correcting method according to claim 7, further integrating differences between the temperature distribution measured before the main measurement and the temperature distribution measured in the main measurement for an entire region directly above the resistor, selecting a closest temperature distribution from predetermined temperature distributions using the integrated value, and calculating an amount of correction for correcting the misread temperature.

11. The measured-temperature correcting method according to claim 7, further comprising determining a difference between the temperature distribution measured before the main measurement and the temperature distribution measured in the main measurement for any point in the channel, selecting a closest temperature distribution from predetermined temperature distributions using the determined difference, and calculating an amount of correction for correcting the misread temperature.

12. The measured-temperature correcting method according to claim 9, wherein the point in the channel is a position in the channel, the position corresponding to an end portion of the resistor.
